(19) United States
(12) Patent Application Publication
(10) Pub. No.: US 2012/0115555 A1
(43) Pub. Date: May 10, 2012

(54) APPARATUS AND METHOD FOR PROVIDING A FISHING GAME USING A MOBILE PROJECTOR

(75) Inventors: Jae-Yong CHO, Bucheon-si (KR); Byeong-Hoon Park, Suwon-si (KR)

(73) Assignee: Samsung Electronics Co., Ltd., Suwon-si (KR)

(21) Appl. No.: 13/293,735

(22) Filed: Nov. 10, 2011

(30) Foreign Application Priority Data
Nov. 10, 2010 (KR) 10-2010-0111474

(51) Int. Cl. A63F 13/00

(52) U.S. Cl. 463/2

(57) ABSTRACT

An apparatus and method for providing a fishing game using a mobile projector are provided. The apparatus includes an output unit for outputting a fishing game image; a projector for projecting the fishing game image output from the output unit onto a projection surface; a sensor unit for calculating a direction and a speed in and at which the apparatus is moved, upon detecting a motion of the apparatus during the fishing game; and a controller for projecting the fishing game image using the projector module, and controlling a change in motion of a specific object in the fishing game image projected onto the projection surface, depending on the calculated direction and speed of the apparatus.

### PRIORITY

This application claims priority under 35 U.S.C. §119(a) to Korean Patent Application Serial No. 10-2010-0111474, which was filed in the Korean Intellectual Property Office on Nov. 10, 2010, the entire disclosure of which is hereby incorporated by reference.

### BACKGROUND OF THE INVENTION

1. Field of the Invention

The present invention relates generally to a fishing game, and more particularly, to an apparatus and method for providing a fishing game using a mobile projector.

2. Description of the Related Art

The term “mobile terminal” refers to, e.g., mobile phones, Personal Digital Assistants (PDAs), smart phones, etc. Further, it is very common for mobile terminals to provide many different types functions, such as messaging, email, photography, gaming, etc.

FIG. 1 is a block diagram illustrating a conventional mobile terminal providing a fishing game.

Referring to FIG. 1, the mobile terminal includes an output unit 101, e.g., a display, a controller 103, a storage 105, an input unit 107, e.g., a keypad, and a sensor unit 109, e.g., a motion sensor.

When the fishing game is played by a user, the output unit 101 outputs an image of the fishing game, and the storage 105 stores at least one event occurring during the fishing game.

Upon receiving a specific input by the user during the fishing game, the input unit 107 delivers the received user input to the controller 103. The sensor unit 109 detects a motion of the mobile terminal during the fishing game, and delivers a strength of the detected motion of the mobile terminal to the controller 103. The controller 103 performs a preset event depending on the strength of the detected motion of the mobile terminal, received from the sensor unit 109.

For example, when performing a casting motion, the user moves the mobile terminal away from his body, and the sensor unit 109 detects the motion and delivers the strength of the detected motion of the mobile terminal to the controller 103. The controller 103 performs the casting within the game, according to the strength of the motion, and an image of the running event, i.e., the casting of the line, is displayed on the output unit 101 for the user.

Upon receiving a user input, such as Pause Game or Quit Game, through the input unit 107, the controller 103 pauses or quits the fishing game, and displays information about the pause or quit of the game on the output unit 101 for the user.

FIG. 2 is a diagram illustrating a screen shot of a conventional mobile terminal when playing an existing fishing game.

Referring to FIG. 2, the fishing game is played in a first-person view, and a fishing game image is displayed on the output unit 101 of the mobile terminal. While watching the fishing game image, the user moves the mobile terminal towards his body when a fish tugs a float 201. The sensor unit 109 detects the motion, and the controller 103 analyzes a strength of the detected motion of the mobile terminal to determine whether the user has successfully hooked the fish.

Upon receiving a user input such as Cut Line 203, View Mission 205, and Voyage Mode 207 from the input unit 107 during the fishing game, the controller 103 pauses the running fishing game, and displays an event corresponding to the user input on the output unit 101 for the user. For example, upon receiving Cut Line 203 input, the controller 103 quits fishing, and returns to a state before casting the float 201.

Upon receiving View Mission 205 input, the controller 103 displays the types of the missions that the user should complete in the current fishing game on the output unit 101.

Upon receiving Voyage Mode 207 input, the controller 103 displays an action of quitting the ongoing fishing and moving to another location, on the output unit 101.

As described above, an existing fishing game on a conventional mobile terminal is played in a first-person view. For example, the game image is displayed on the output unit 101, such as an Liquid Crystal Display (LCD) panel mounted in the mobile terminal. However, because the game is played on the output unit 101, which is generally a small screen, this reduces the realism of the game, and although the user plays the game using a motion sensor in the sensor unit, the manipulation method or game play method is different from the real action of fishing with a fishing rod, diminishing the user's experience.

### SUMMARY OF THE INVENTION

Accordingly, the present invention is designed to substantially solve at least the problems and/or disadvantages above and to provide at least the advantages described below.

An aspect of the present invention is to provide an apparatus and method for providing a realistic fishing game by projecting a fishing game image using a mobile projector included in a mobile terminal.

In accordance with an aspect of the present invention, an apparatus for providing a fishing game is provided. The apparatus includes an output unit for outputting a fishing game image; a projector for projecting the fishing game image output from the output unit onto a projection surface; a sensor unit for calculating a direction and a speed in and at which the apparatus is moved, upon detecting a motion of the apparatus during the fishing game; and a controller for projecting the fishing game image using the projector module, and controlling a change in motion of a specific object in the fishing game image projected onto the projection surface, depending on the calculated direction and speed of the apparatus.

In accordance with another aspect of the present invention, a method is provided for providing a fishing game using a mobile projector. The method includes projecting a fishing game image onto a projection surface; detecting a motion of an apparatus including the mobile projector during the fishing game; calculating a direction and a speed in and at which the apparatus has moved; and changing a specific object in the fishing game image projected onto the projection surface depending on the calculated direction and speed.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a block diagram illustrating a conventional mobile terminal for providing a fishing game;

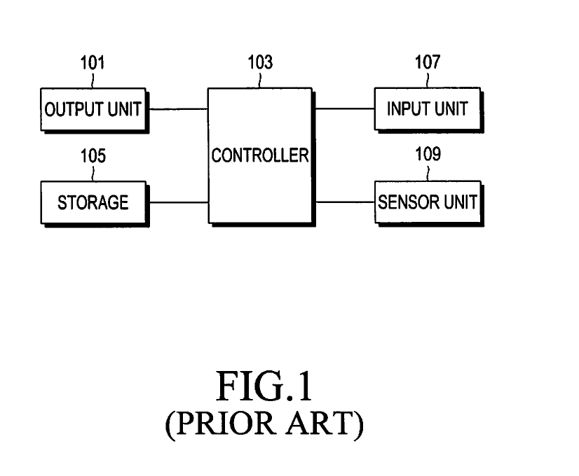

FIG. 2 is a diagram illustrating a screen shot of a conventional mobile terminal when playing an existing fishing game;

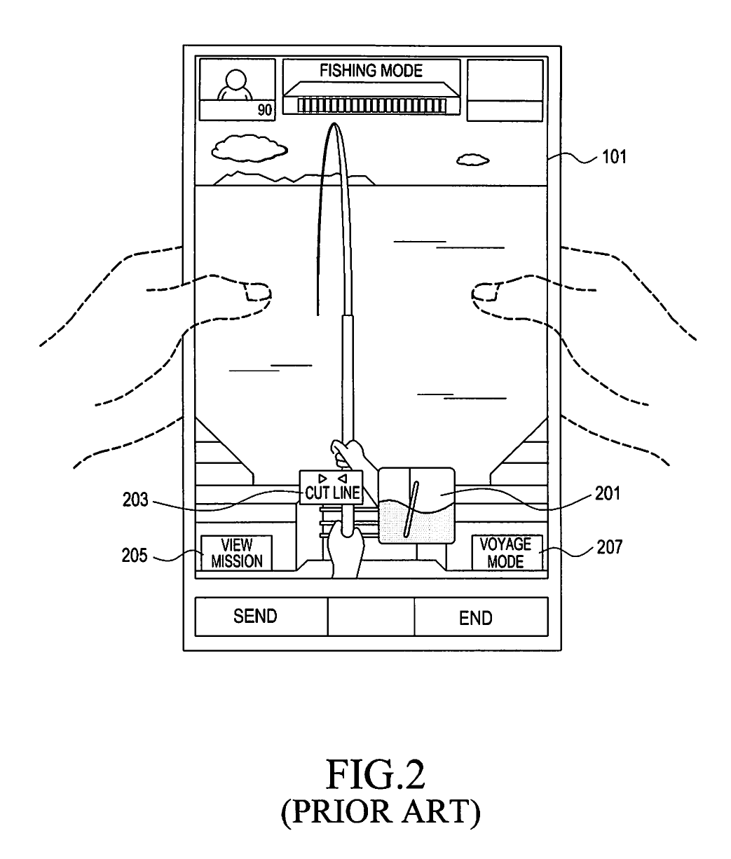

FIG. 3 is a block diagram illustrating a mobile terminal for providing a fishing game according to an embodiment of the present invention;

FIG. 4 is a diagram illustrating an action of playing a fishing game using a projector module according to an embodiment of the present invention;

FIGS. 5A and 5B are diagrams illustrating actions of playing a fishing game based on a motion of or a change in location of a mobile terminal according to an embodiment of the present invention; and

FIG. 6 is a flowchart illustrating a method of providing a fishing game using a projector module according to an embodiment of the present invention.

Throughout the drawings, the same drawing reference numerals will be understood to refer to the same elements, features and structures.

### DETAILED DESCRIPTION OF EMBODIMENTS OF THE INVENTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

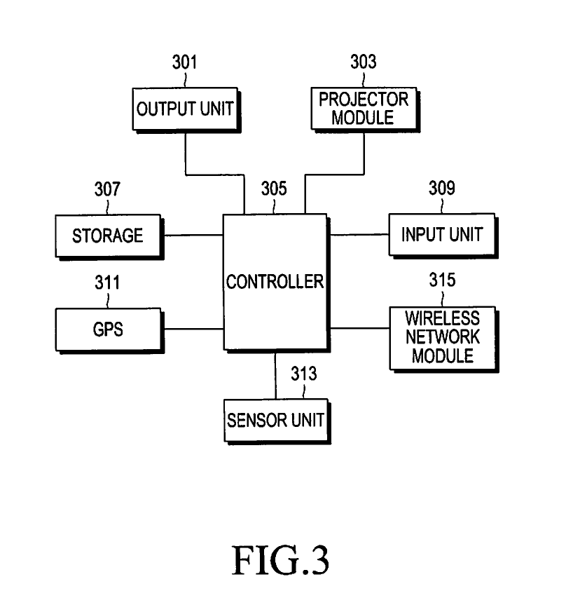

FIG. 3 is a block diagram illustrating a mobile terminal for providing a fishing game according to an embodiment of the present invention.

Referring to FIG. 3, the mobile terminal includes an output unit 301, e.g., a display, a projector module 303, a controller 305, a storage 307, e.g., a memory device, an input unit 309, e.g., a keypad or touch screen, a Global Positioning System (GPS) 311, a sensor unit 313, e.g., a motion sensor, and a wireless network module 315.

When the fishing game is played by a user, the output unit 301 outputs a fishing game image under control of the controller 305. The projector module 303 projects the fishing game image output from the output unit 301 under control of the controller 305. The fishing game image may be output on the output unit 301, may be projected through the projector module 303, or may be projected through the projector module 303 while being output on the output unit 301. This operation may be controlled by the controller 305.

The storage 307 stores at least one event occurring during the fishing game. Types of events may include View Mission, Cut Line, Cast Float, Lift Fishing Rod, Reel, Move to Another Location, etc., and the stored events may be used under control of the controller 305.

Upon receiving a user input such as touching a touch screen and pressing a button by the user during the fishing game, the input unit 309 delivers the user input to the controller 305.

The GPS 311 obtains the current location information of the mobile terminal, and the wireless network module 315 transmits the obtained current location information to a server and receives, from the server, information about the types or amount of fish, which corresponds to the transmitted current location information. The controller 305 sets the received information about the types or amount of fish, in the fishing game. That is, when the current location of the mobile terminal changes, the received information about the types or amount of fish also changes.

In addition, the location of the point where the user throws the float on the projection surface may be changed in response to the change in the current location. An example of these operations will be described in more detail below.

The sensor unit 313 includes a gyro sensor and an acceleration sensor. The sensor unit 313 detects a motion of the mobile terminal during fishing game using the gyro sensor and the acceleration sensor, and delivers, to the controller 305, information about the direction in which the mobile terminal moves, and the speed at which the mobile terminal moves.

During the fishing game, the controller 305 determines whether to output the fishing game image on the output unit 301 or to project it through the projector module 303. The controller 305 may project the fishing game image through the projector module 303 while outputting it on the output unit 301, according to user settings. The controller 305 may perform a preset event depending on the strength of the motion of the mobile terminal, received from the sensor unit 313, and may apply, to the fishing game, the information about the types or amount of fish corresponding to the current location information, received from the wireless network module 315. Additionally, the controller 305 may allow the user to access the server and play the fishing game with another user enjoying the same fishing game from another mobile terminal.

Although the output unit 301 and the input unit 309 are configured independently in FIG. 3, if the display of the mobile terminal is a touch screen-type display, the touch screen may serve as both the output unit 301 and the input unit 309.

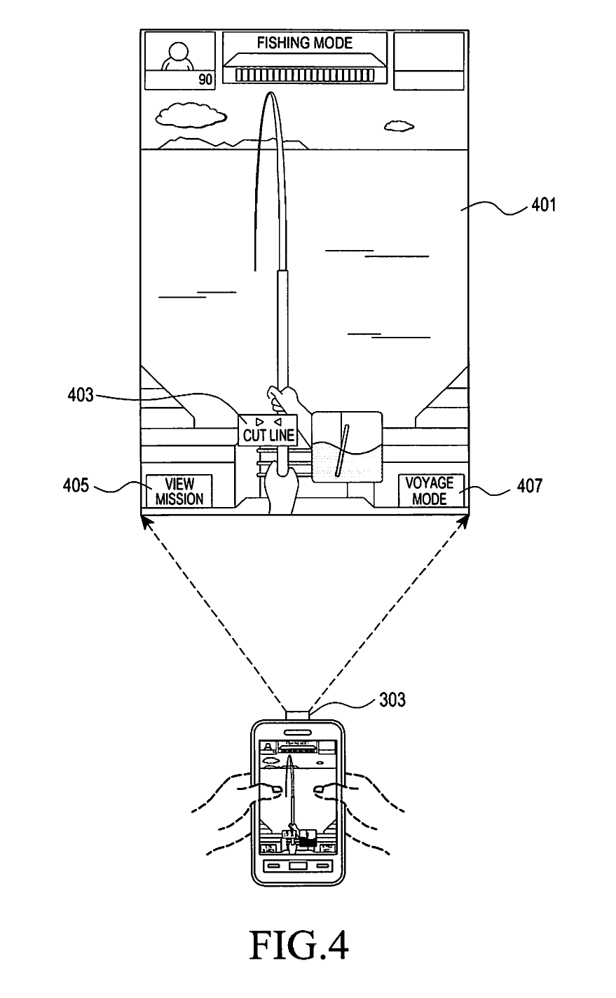

FIG. 4 is a diagram illustrating an action of playing a fishing game using a projector module according to an embodiment of the present invention.

Referring to FIG. 4, a fishing game image is output on the output unit 301 of the mobile terminal and is projected by the projector module 303 mounted in the mobile terminal. Accordingly, the user may enjoy the fishing game, by watching the projected fishing game image 401. The fishing game image 401 projected by the projector module 303 can be seen in much greater than the fishing game image output on the output unit 301 of the mobile terminal due to the fishing game image 401 projected by the projector module 303 being much larger than the fishing game image output on the output unit 301 of the mobile terminal. Accordingly, the fishing experience is more realistic and the user may enjoy the fishing game more.

The user inputs a user input such as Cut Line 403, View Mission 405, and Voyage Mode 407 during the fishing game, using the input unit 309 of the mobile terminal. When the user input is made, the controller 305 pauses the running fishing game, and displays an event corresponding to the user input on the output unit 301 for the user, and/or in the fishing game image 401 projected by the projector module 303.

For example, upon receiving the Cut Line 403 input, the controller 305 quits fishing, and returns to a state before casting the float.

Upon receiving the View Mission 405 input, the controller 305 displays and/or projects the types of the missions that the user should complete in the current fishing game.

Upon receiving the Voyage Mode 407 input, the controller 305 displays and/or projects, an action of quitting the ongoing fishing and moving to another location.

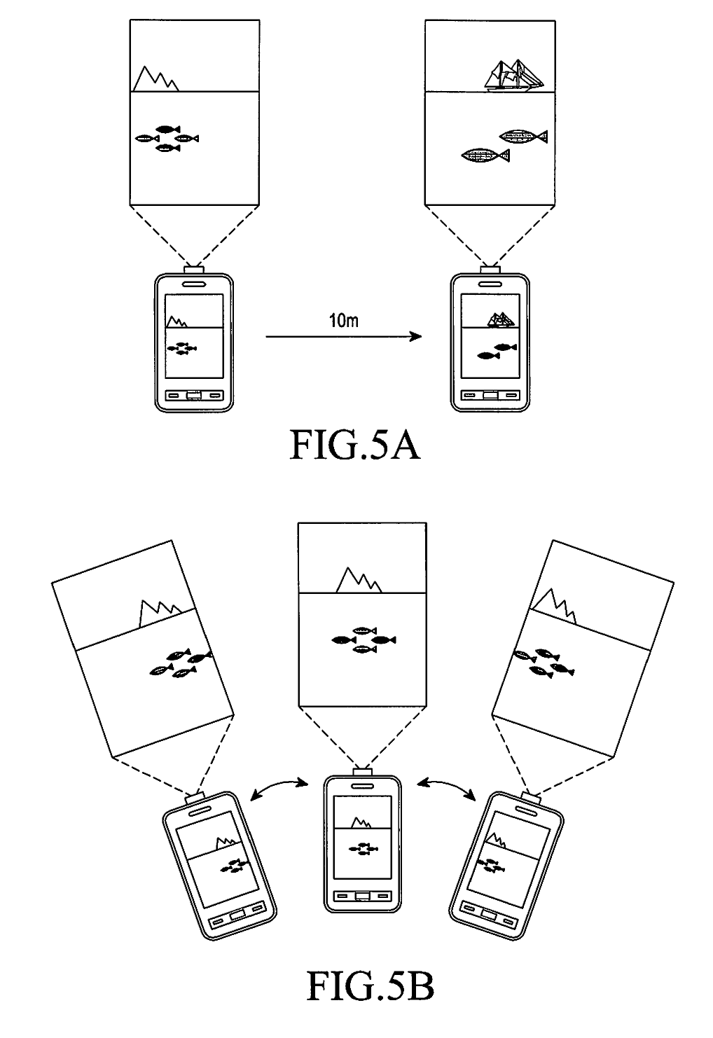

FIGS. 5A and 5B are diagrams illustrating actions of playing a fishing game based on a motion of or a change in location of a mobile terminal according to an embodiment of the present invention. Specifically, FIG. 5A illustrates a fishing game when the mobile terminal has moved from a current location to another location, and FIG. 5B illustrates a fishing game when a user changes the orientation of the mobile terminal in a current location.

Referring to FIG. 5A, a user moves to another location, which is 10 m away from an original location. A background image of the fishing game image displayed and/or projected, and the sizes of and the number of fish shown in the water change.

More specifically, when the user moves, the GPS 311 of the mobile terminal detects change in location of the mobile terminal. The wireless network module 315 transmits information about the new location of the mobile terminal to the server, which then transmits information about the types or amount of fish corresponding to the new location information of the mobile terminal, to the wireless network module 315. The controller 305 applies the information about the types or amount of fish, received through the wireless network module 315, to the fishing game. As illustrated in FIG. 5A, the mobile terminal may change the background image as well.

Referring to FIG. 5B, when a user changes the orientation, i.e., the direction, of the mobile terminal, e.g., moves the terminal from side to side, in a current location, the background of the fishing game image displayed and/or projected and the location of the fish reflected in the water changes. In FIG. 5B, the sensor unit 313, together with the GPS 311, detects a change in the orientation of the mobile terminal, and the controller 305 controls the background image of the fishing game image and the location of the fish reflected in the water, according to the change.

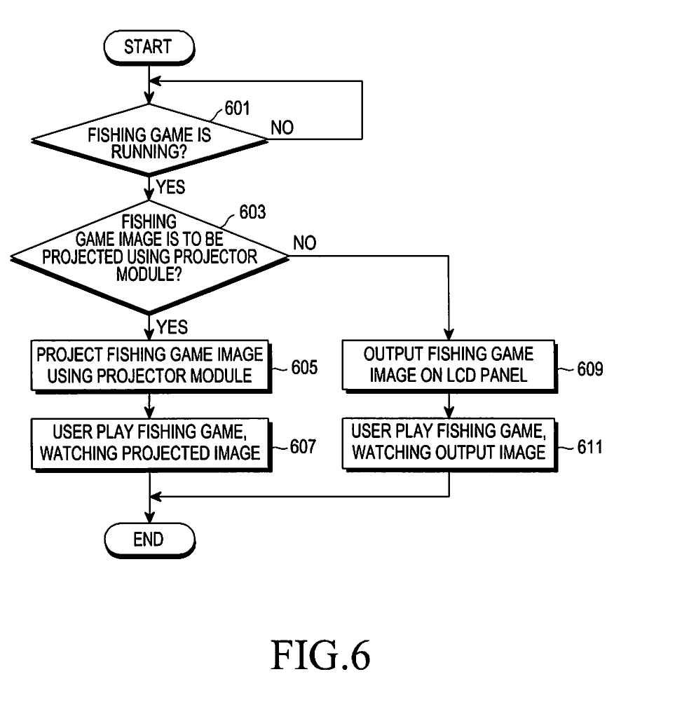

FIG. 6 is a flowchart illustrating a method of providing a fishing game using a projector module according to an embodiment of the present invention.

Referring to FIG. 6, in step 601, the mobile terminal determines whether the fishing game is running. When the fishing game is not running, the mobile terminal repeats step 601, until the fishing game is running.

When the fishing game is running, in step 603, the mobile terminal determines whether to project the fishing game image onto a projection screen using a projector module. If the mobile terminal determines not to project the fishing game image using the projector module, the mobile terminal outputs the fishing game image on its output unit, e.g., an LCD panel, in step 609. Thereafter, in step 611, the user to plays the fishing game, watching the output fishing game image on the mobile terminal display.

When the mobile terminal determines to project the fishing game image using the projector module, the mobile terminal projects the fishing game image onto a projection surface using the projector module in step 605. Thereafter, in step 607, the user plays the fishing game, watching the projected fishing game image.

Although not illustrated in FIG. 6, even while projecting the fishing game image using the projector module, the mobile terminal may simultaneously output the fishing game image on the LCD panel. Therefore, if the user wants to make another user input during the fishing game, the user may make the user input on the LCD panel.

Additionally, it is also possible for the mobile terminal to display a image on the display, that is different than the fishing game image being projected. For example, when projecting a fishing game image like that illustrated in FIG. 4, the mobile terminal could display an image of a reel on the display of the mobile terminal, when the user turns reel through a touch screen input in order to reel in the cast line in the projected fishing game image.

As is apparent from the foregoing description, an apparatus and method are provided, wherein a fishing game image is projected onto a projection area using mobile projector included in (or connected to) in the mobile terminal, increasing the fishing game image in size. Thus, the user may play the fishing game with the actual motion of lifting up the mobile terminal, with the mobile terminal wrapped in his hand, while watching the large projected image, thereby increasing the realism of the fishing game.

While the present invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. An apparatus for providing a fishing game, comprising:
an output unit for outputting a fishing game image;
a projector for projecting the fishing game image output from the output unit onto a projection surface;
a sensor unit for calculating a direction and a speed in and at which the apparatus is moved, upon detecting a motion of the apparatus during the fishing game; and
a controller for projecting the fishing game image using the projector module, and controlling a change in motion of a specific object in the fishing game image projected onto the projection surface, depending on the calculated direction and speed of the apparatus.

2. The apparatus of claim 1, further comprising:
a memory for storing a preset event occurring during the fishing game; and
an input unit for receiving a user input during the fishing game, and delivering the user input to the controller.

3. The apparatus of claim 1, further comprising:
a Global Positioning System (GPS) for determining location information of the apparatus; and
a wireless network module for transmitting current location information of the apparatus to a server, and receiving, from the server, information about at least one of types or amount of fish, corresponding to the current location information.

4. The apparatus of claim 3, wherein when the apparatus moves to a new location, the controller applies, to the fishing game, information about at least one of a change in the types of fish, the amount of fish, and a background image, corresponding to information about the new location to which the apparatus has moved, and projects an image of the fishing game reflecting the changed information.

5. The apparatus of claim 1, wherein when an orientation of the apparatus changes, the controller changes the fishing game image, based on the change in the orientation.

6. The apparatus of claim 1, wherein the sensor unit comprises:
a gyro sensor; and
an acceleration sensor.

7. A method for providing a fishing game using a mobile projector, the method comprising:
projecting a fishing game image onto a projection surface;
detecting a motion of an apparatus including the mobile projector during the fishing game;
calculating a direction and a speed in and at which the apparatus has moved; and
changing a specific object in the fishing game image projected onto the projection surface depending on the calculated direction and speed.

8. The method of claim 7, further comprising displaying the fishing game image projected through the mobile projector on an output unit of the apparatus.

9. The method of claim 7, further comprising:
receiving information about a current location of the apparatus;
transmitting the information about the current location to a server;
receiving information about types and amount of fish corresponding to the information about the current location, from the server; and
applying the received information to the fishing game.

10. The method of claim 7, further comprising:
detecting that the apparatus moves to a new location;
applying, to the fishing game, information about a change in types of fish, amount of fish, or a background image, corresponds to information about the new location; and
projecting an image of the fishing game, to which the information about the change is applied.

11. The method of claim 7, further comprising:
detecting that an orientation of the apparatus changes;
applying, to the fishing game, information about a change in types of fish, amount of fish, or a background image, corresponding to the change in the orientation of the apparatus; and
projecting an image of the fishing game, to which the information about the change is applied.

12. An apparatus for providing a fishing game, comprising:
a touch screen display for outputting a first fishing game image, and receiving a user input;
a projector for projecting a second fishing game image onto a projection surface; and
a controller for recognizing the user input received through the touch screen display, and a second fishing game image, depending on the user input.

13. The apparatus of claim 12, wherein the second fishing game image comprises a fishing line cast into water,
wherein the first fishing game image comprises a fishing reel,
wherein the user input comprises a circular motion that winds the fishing reel included in the first fishing game image, and
wherein the fishing line cast into water in the second fishing game image is reeled in, in response to the user input.

14. The apparatus of claim 12, further comprising a sensor unit for detecting a motion of the apparatus during the fishing game and calculating a direction in which and a speed at which the apparatus is moved.

15. The apparatus of claim 14, wherein when the apparatus is quickly moved away from a user, the second fishing game image comprises a fishing line being cast into water.

16. The apparatus of claim 14, wherein the sensor unit comprises:
a gyro sensor; and
an acceleration sensor.
